(19) United States
(12) Patent Application Publication
(10) Pub. No.: US 2012/0051909 A1
(43) Pub. Date: Mar. 1, 2012

(54) FLUID ELASTOMERIC DAMPER ASSEMBLY

(76) Inventor: Dennis P. McGuire, Erie, PA (US)

(21) Appl. No.: 13/266,888

(22) PCT Filed: Apr. 28, 2010
(86) PCT No.: PCT/US2010/032717

§ 371 Date: Oct. 28, 2011

Related U.S. Application Data
(60) Provisional application No. 61/173,385, filed on Apr. 28, 2009.

(51) Int. Cl. F16F 9/19; B64C 11/04; F01D 25/04

(52) U.S. Cl. 416/1; 188/297; 188/313; 188/317; 188/314; 416/140

(57) ABSTRACT

A rotary wing system with a troublesome motion when rotating about a rotation axis, including a fluid tubular damper with a damper fluid for controlling the troublesome motion. The damper has an inboard and an outboard end, the inboard end attached to a rotary wing system inboard member proximate the rotation axis and the outboard end attached to a rotary wing system outboard member. The damper is terminated with a nonelastomeric end cap and contains damper fluid in at least an inboard and an outboard variable volume nonelastomeric working chamber which is worked by a nonelastomeric damper piston and a relative motion between the rotary wing system members. The damper includes a dynamically variable elastomeric volume compensator chamber in fluid communication with the working chambers, with the communication a controlled communication with the fluid flowed through control valves towards the working chambers. The damper inboard end is sealed with a sole single acting one ended bonded elastomeric member, the bonded elastomeric member including an intermediate elastomer bonded between an inside and an outside nonelastomeric outer member wherein the inside member is grounded with a damper piston shaft and the outside member is grounded with the tubular housing and the second outboard end. The damper piston shaft connects the damper piston with the damper inboard end and the rotary wing system inboard member with the troublesome motion working the damper fluid between the working chambers.

### CROSS REFERENCE

This application claims the benefit of, and incorporates herein by reference, U.S. Provisional Patent Application No. 61/173385 filed on Apr. 28, 2009.

### FIELD OF THE INVENTION

The invention relates to the field of rotary wing systems with working fluids. The invention relates to the field of controlling rotating blades with troublesome motion. More particularly the invention relates to the field of aircraft rotary wing blade dampers with working fluids and helicopter rotary wing fluid dampers.

### SUMMARY OF THE INVENTION

In an embodiment the invention includes a rotary wing system with at least one rotating blade rotating about a rotation axis, the rotary wing system having a troublesome motion when rotating about the rotation axis. The system including a fluid tubular damper with a damper fluid for controlling the troublesome motion. The fluid damper having an first inboard end and an second outboard end, the fluid damper first inboard end attached to a first rotary wing system inboard member proximate the rotation axis and the second outboard end attached to a second rotary wing system outboard member distal from the rotation axis. The fluid damper comprised of a tubular housing between the two ends, the fluid damper tubular housing second outboard end terminated with a nonelastomeric end cap, and containing a damper fluid in at least a first inboard variable volume nonelastomeric working chamber and a second outboard variable volume nonelastomeric working chamber which is worked by a nonelastomeric damper piston and a relative motion between the first rotary wing system inboard member and the second rotary wing system outboard member to control the troublesome motion. The fluid damper including a dynamically variable elastomeric volume compensator chamber in fluid communication with the damper fluid. Preferably the volume compensator chamber volume varies dynamically with the relative motion of the damper. Preferably the volume compensator chamber fluid communication is a controlled communication with the fluid flowed through control valves towards the working chambers, preferably check valves, such as one way flow control check valves. Preferably the fluid damper tubular housing first inboard end is sealed with a sole single acting one ended bonded elastomeric member, the bonded elastomeric member including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the tubular housing and the second outboard end wherein the damper piston shaft connects the damper piston with the fluid damper first inboard end and the first rotary wing system inboard member with the troublesome motion working the damper fluid between the first inboard variable volume nonelastomeric working chamber and the second outboard variable volume nonelastomeric working chamber.

In an embodiment the invention includes a method for controlling a rotating blade. The method comprises providing a rotating blade which rotates about a rotation axis. The method comprises providing a fluid tubular damper with a damper fluid, the fluid damper having an first inboard end and an second outboard end, the fluid damper comprised of a tubular housing between the two ends, the fluid damper tubular housing second outboard end terminated with a nonelastomeric end cap, the damper containing a damper fluid in at least a first inboard variable volume nonelastomeric working chamber and a second outboard variable volume nonelastomeric working chamber which is worked by a relative motion nonelastomeric damper piston, the fluid damper including a dynamically variable volume compensator chamber in fluid communication with the damper fluid, the fluid damper tubular housing first inboard end sealed with a bonded elastomeric member, the bonded elastomeric member including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the tubular housing and the second outboard end wherein the damper piston shaft connects the damper piston with the fluid damper first inboard end and the first rotary wing system inboard member with the troublesome motion working the damper fluid between the first inboard variable volume nonelastomeric working chamber and the second outboard variable volume nonelastomeric working chamber. The method comprises attaching the fluid damper first inboard end to a first rotary wing system inboard member proximate a rotation axis. The method comprises attaching the second outboard end to a second rotary wing system outboard member distal from the rotation axis.

In an embodiment the invention includes a rotating single acting blade damper for a blade rotating about a rotation axis, the blade damper including a fluid damper with a damper fluid for controlling a troublesome blade motion, the fluid damper having a first inboard elastomeric end and a second distal nonelastomeric outboard end, the fluid damper first elastomeric inboard end for attachment to a first inboard member and the second outboard end for attachment to a second outboard member, the fluid damper comprised of a tubular housing, the fluid damper tubular housing second end capped with an end cap, the damper containing a damper fluid in at least a first inboard variable volume nonelastomeric working chamber and a second outboard variable volume nonelastomeric working chamber which is worked by a relative motion damper piston, the fluid damper including a volume compensator chamber in fluid communication with the damper fluid, the fluid damper tubular housing first end sealed with a bonded elastomeric member, the bonded elastomeric member including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the tubular housing and the second end wherein the damper piston shaft connects the damper piston with the fluid damper first end and the first inboard member with the troublesome blade motion working the damper fluid between the first variable volume working chamber and the second variable volume working chamber.

In an embodiment the invention includes a method of making a damper. The method includes providing housing for containing a damper fluid in at least a first working chamber and at least a second working chamber. The method includes providing a second nonelastomeric outboard end for capping a second outboard distal end of the housing. The method includes providing a bonded elastomeric member assembly, the bonded elastomeric member assembly including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the tubular housing, to contain a damper fluid within the housing and provide for a relative axial motion of the damper piston shaft relative to the housing and the second nonelastomeric outboard end, with the damper piston shaft carrying the motion to a relative motion nonelastomeric damper internal piston between a first inboard variable volume nonelastomeric working chamber and a second outboard variable volume nonelastomeric working chamber.

In an embodiment the invention includes a method of repairing an aircraft with a troublesome blade motion. The method includes providing an aircraft with a used nonelastomeric hydraulic damper. Preferably the aircraft is a helicopter with an articulated helicopter rotor. Preferably the used nonelastomeric hydraulic damper is free of bonded elastomeric members, preferably free of annular elastomeric members with appreciable thickness relative to their respective diameters, preferably the hydraulic damper is without nondynamic elastomeric bonded members containing the fluid and allowing motion. Preferably the used nonelastomeric hydraulic damper has nonelastomeric end caps on both ends, one end with a shaft and a leaking dynamic seal. The method includes removing the used nonelastomeric hydraulic damper. The method includes providing a bonded elastomeric fluid damper having a first inboard elastomeric end and a second distal nonelastomeric outboard end, the bonded elastomeric fluid damper comprised of a housing between the two ends, the fluid damper housing second outboard end capped with an nonelastomeric end cap, the damper containing a damper fluid in at least a first inboard variable volume nonelastomeric working chamber and a second outboard variable volume nonelastomeric working chamber which is worked by a relative motion nonelastomeric damper piston, the fluid damper including a volume compensator chamber in fluid communication with the damper fluid, the fluid damper housing first inboard end sealed with a bonded elastomeric member, the bonded elastomeric member including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the housing and the second outboard end wherein the damper piston shaft connects the damper piston with the fluid damper first inboard end and the first inboard member, and attaching the bonded elastomeric fluid damper in place of the removed used nonelastomeric hydraulic damper with the troublesome blade motion working the damper fluid between the first inboard variable volume nonelastomeric working chamber and the second outboard variable volume nonelastomeric working chamber.

In an embodiment the invention includes a fluid damper, the fluid damper including a damper fluid for controlling a troublesome motion. The fluid damper having a first elastomeric end and a second distal nonelastomeric end, the fluid damper first elastomeric end for attachment to a first moving member and the second end for attachment to a second moving member. The fluid damper comprised of a housing, the fluid damper housing second outboard end capped with an nonelastomeric end cap, the damper containing a damper fluid in at least a first variable volume nonelastomeric working chamber and a second variable volume nonelastomeric working chamber which is worked by a relative motion nonelastomeric damper piston, the fluid damper including a volume compensator chamber in fluid communication with the damper fluid, the fluid damper housing first end sealed with a bonded elastomeric member, the bonded elastomeric member including an intermediate elastomer bonded between an inside nonelastomeric outer surface and an outside nonelastomeric inner surface wherein the inside nonelastomeric outer surface is grounded with a nonelastomeric damper piston shaft and the outside nonelastomeric inner surface is grounded with the housing and the second end wherein the damper piston shaft connects the damper piston with the fluid damper first end and the first moving member moving relative to the second moving member working the damper fluid between the first variable volume nonelastomeric working chamber and the second variable volume nonelastomeric working chamber.

In an embodiment the invention includes a fluid damper, the fluid damper including a damper fluid for controlling a troublesome motion. The fluid damper having a first end and a second distal nonelastomeric end, the fluid damper first end for attachment to a first moving member and the second end for attachment to a second moving member. The fluid damper is comprised of a housing, the fluid damper housing second end capped with an nonelastomeric end cap, the damper containing a damper fluid in at least a first variable volume nonelastomeric working chamber and a second variable volume nonelastomeric working chamber which is worked by a relative motion nonelastomeric damper piston, the fluid damper including a volume compensator chamber in fluid communication with the damper fluid, the fluid damper housing first end comprised of a bonded nonelastomeric shaft elastomeric means for plugging the fluid damper housing first end wherein the fluid is contained within the housing and a nonelastomeric damper piston shaft extends inside into the housing towards the second end wherein the damper piston shaft connects with the damper piston, wherein the first moving member moving relative to the second moving member working the damper fluid between the first variable volume nonelastomeric working chamber and the second variable volume nonelastomeric working chamber.

In an embodiment the invention includes a rotating single acting blade damper for a blade rotating about a rotation axis, the blade damper including a fluid damper with a damper fluid for controlling a troublesome blade motion. The fluid damper includes a first inboard elastomeric end and a second distal nonelastomeric outboard end, the fluid damper first elastomeric inboard end for attachment to a first inboard member and the second outboard end for attachment to a second outboard member. The fluid damper is comprised of a housing with a fluid damper housing second outboard end capped with an nonelastomeric end cap, the damper containing the damper fluid in at least a first inboard variable volume nonelastomeric working chamber and a second outboard variable volume nonelastomeric working chamber which is worked by a relative motion nonelastomeric damper piston along a piston shaft axis, the fluid damper including a dynamically variable elastomeric volume compensator chamber in fluid communication with the damper fluid, the fluid damper tubular housing first inboard end sealed with a bonded elastomeric member, the bonded elastomeric member including an intermediate elastomer bonded between an inside nonelastomeric inner member and an outside nonelastomeric outer member wherein the inside nonelastomeric inner member is grounded with a damper piston shaft and the outside nonelastomeric outer member is grounded with the tubular housing and the second outboard end wherein the damper piston shaft connects the damper piston with the fluid damper first inboard end and the first inboard member with the troublesome blade motion working the damper fluid between the first inboard variable volume nonelastomeric working chamber and the second outboard variable volume nonelastomeric working chamber.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principals and operation of the invention.

### BRIEF DESCRIPTION OF THE DRAWINGS

FIG. 1 illustrates an aircraft vehicle with a rotary wing system.

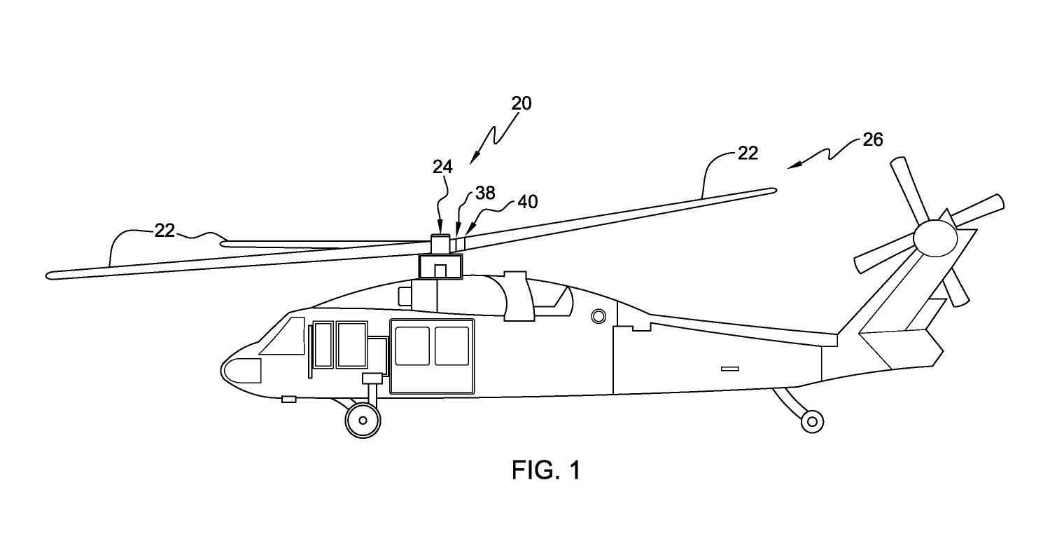

FIG. 2 illustrates a fluid damper with a first end rod end member and a second end rod end member.

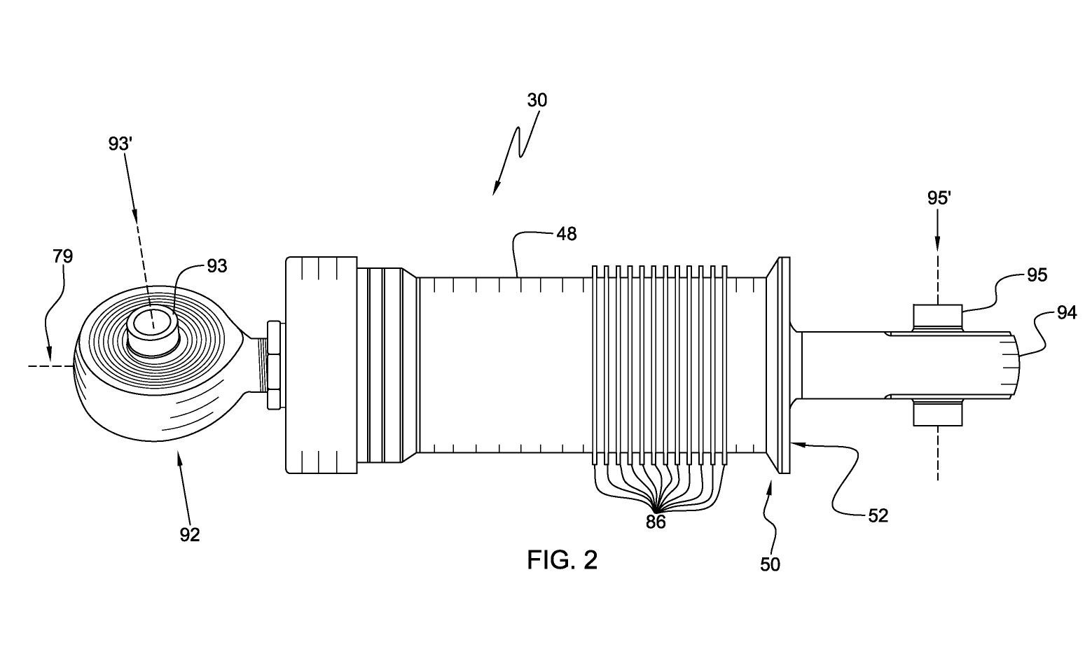

FIG. 3 illustrates a fluid damper cross section and the internals of a fluid damper.

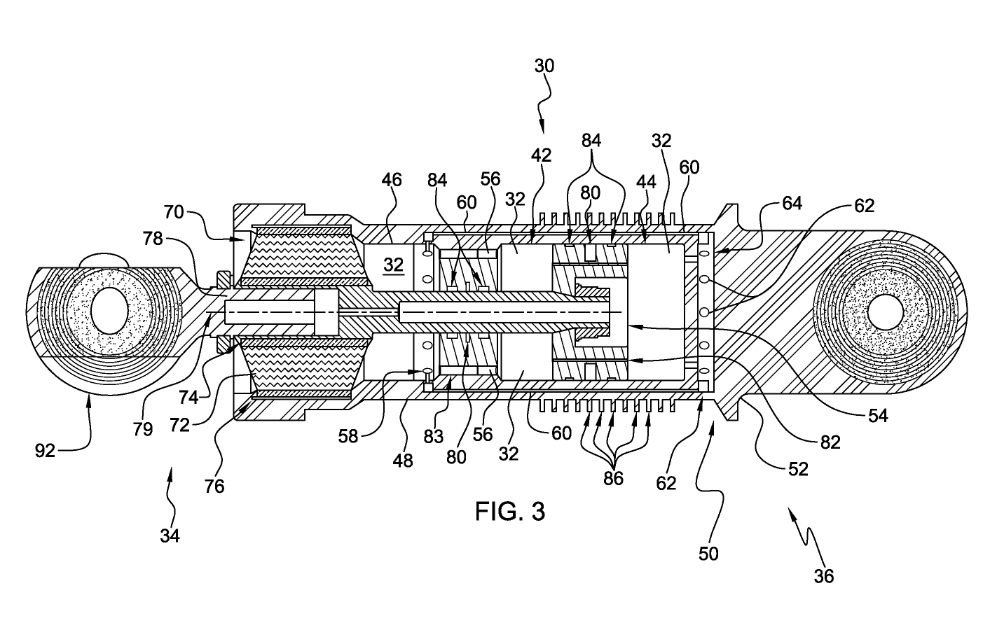

FIG. 4 illustrates the internals of a fluid damper.

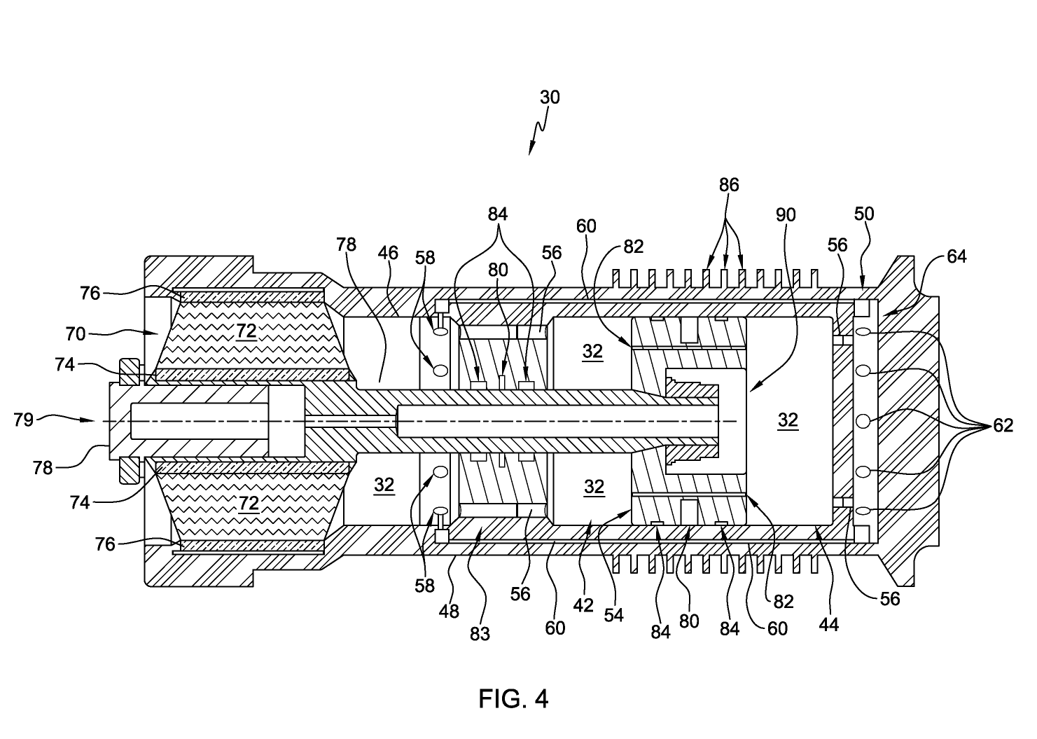

FIG. 5 illustrates fluid damper components.

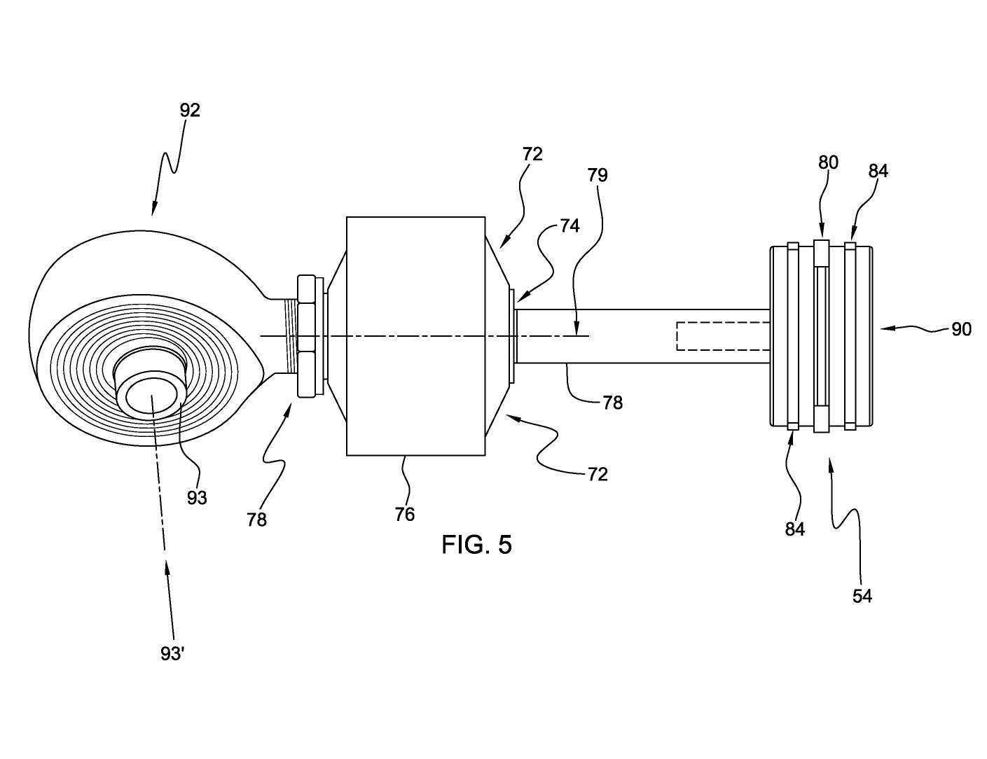

FIG. 6 illustrates a fluid damper bonded elastomeric member.

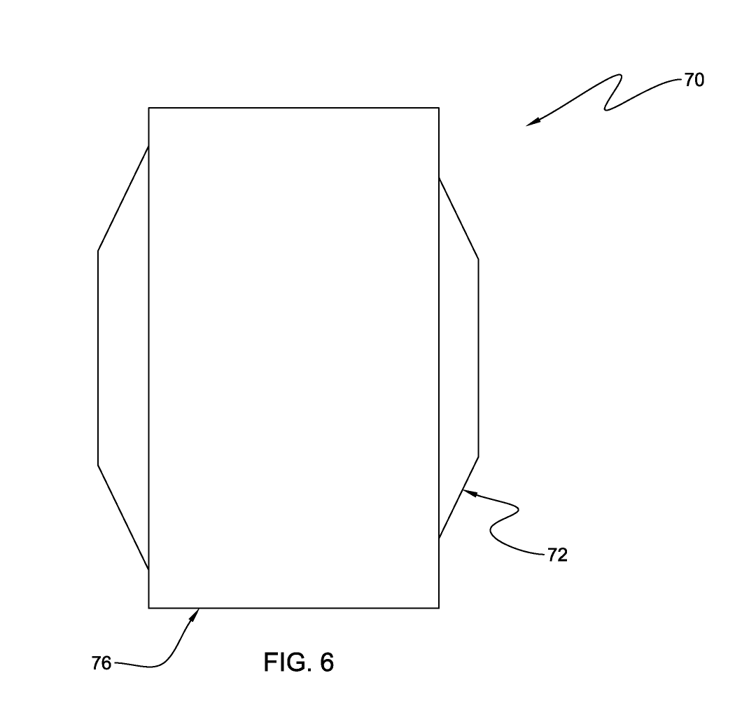

FIG. 7 illustrates a damper.

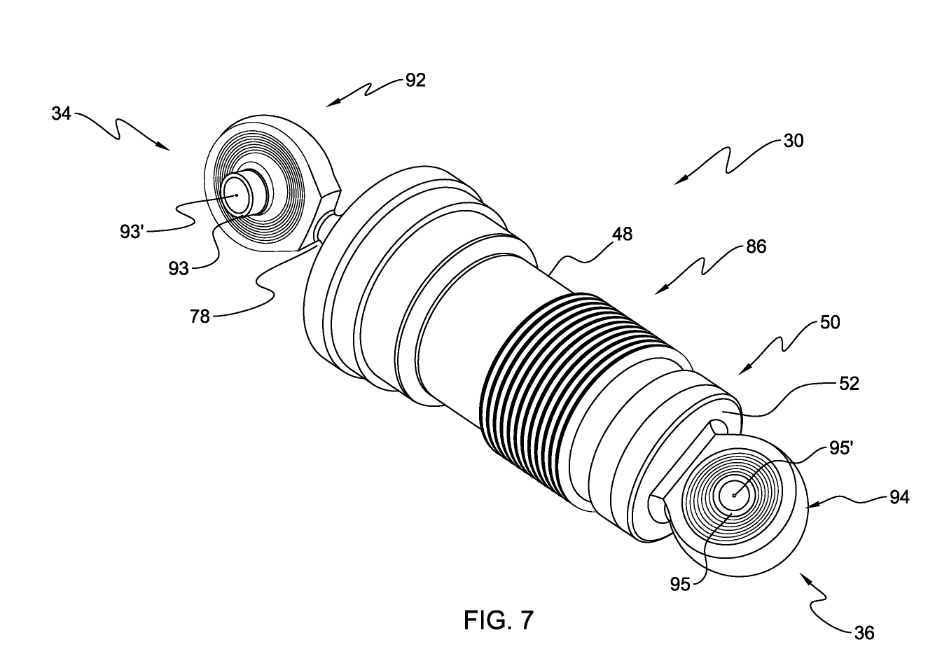

FIG. 8 illustrates a cross section of a damper and its internal components.

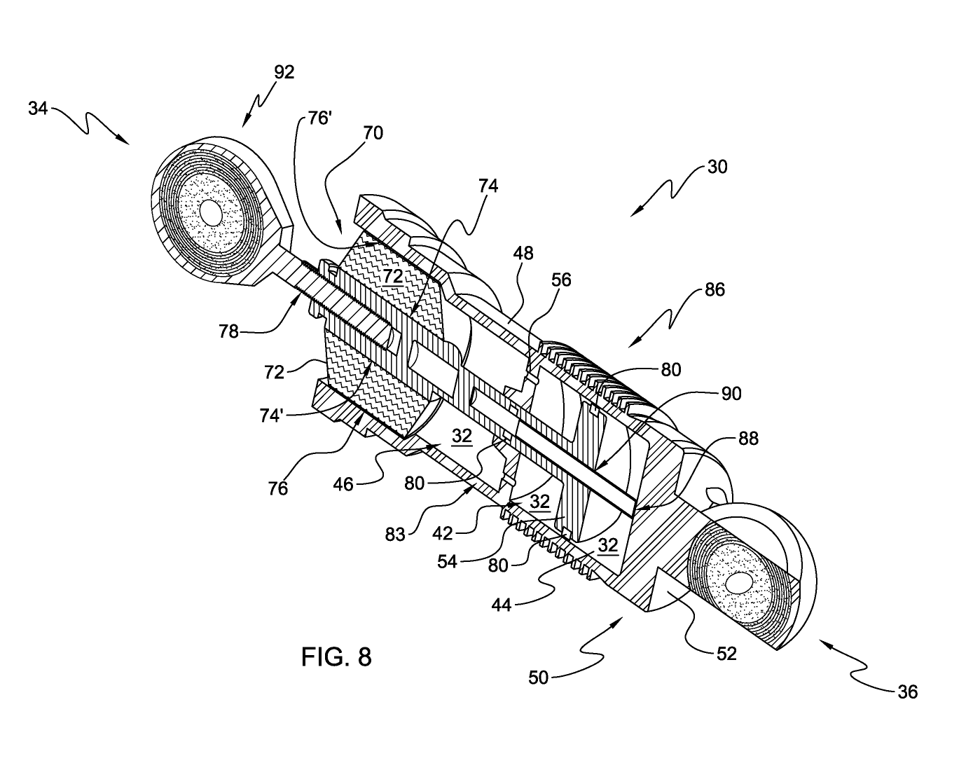

FIG. 9 illustrates a cross section of a damper and its internal components.

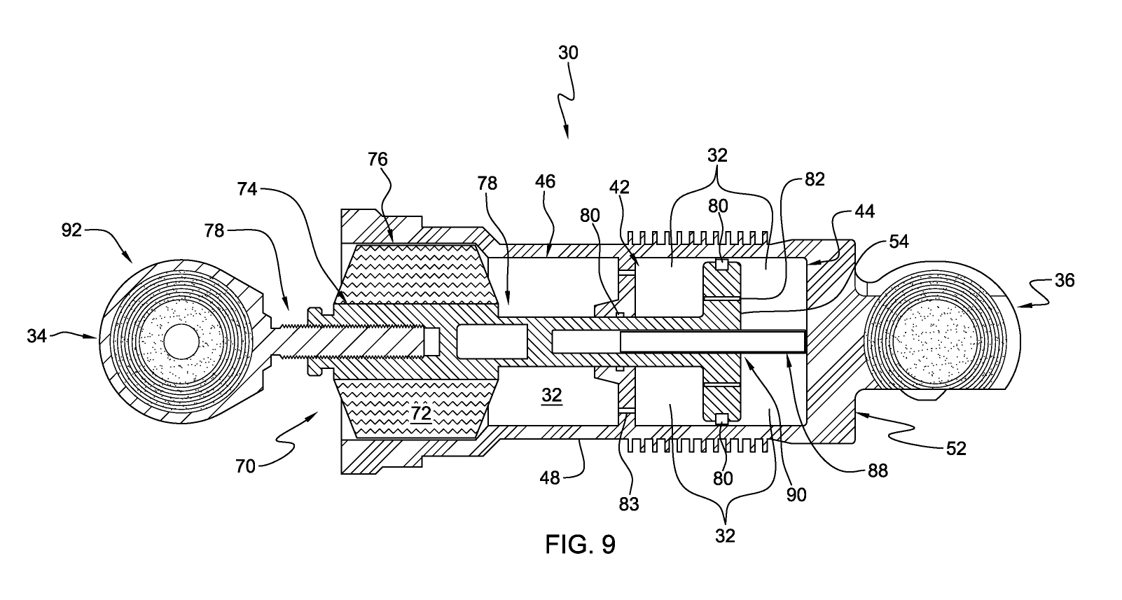

FIG. 10 illustrates a cross section of a damper and its components.

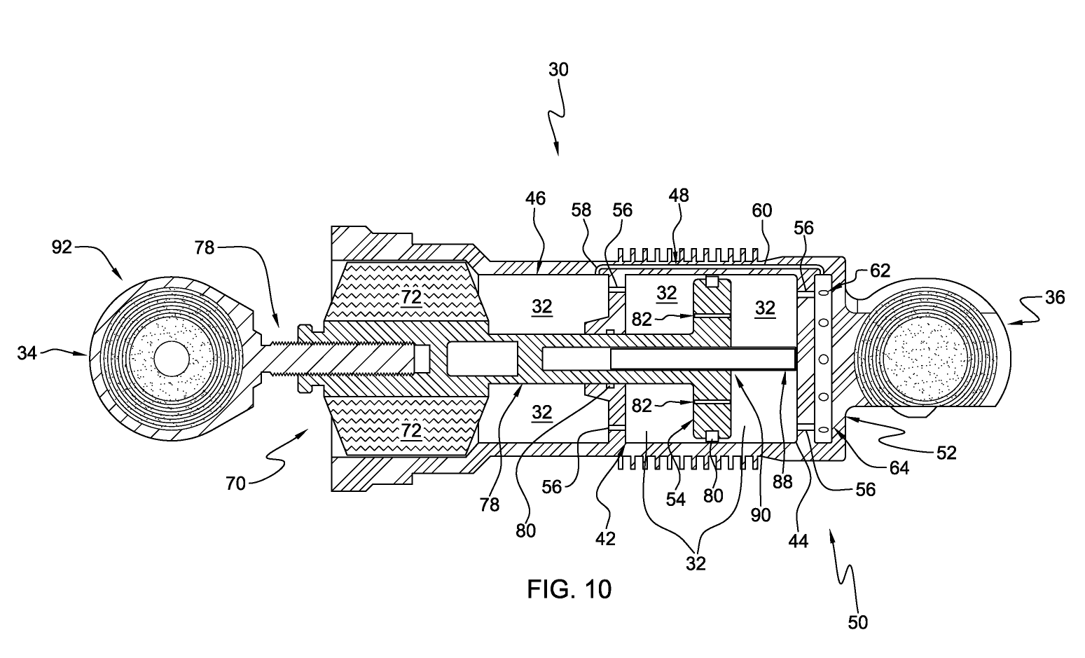

FIG. 11 illustrates a rotary wing system.

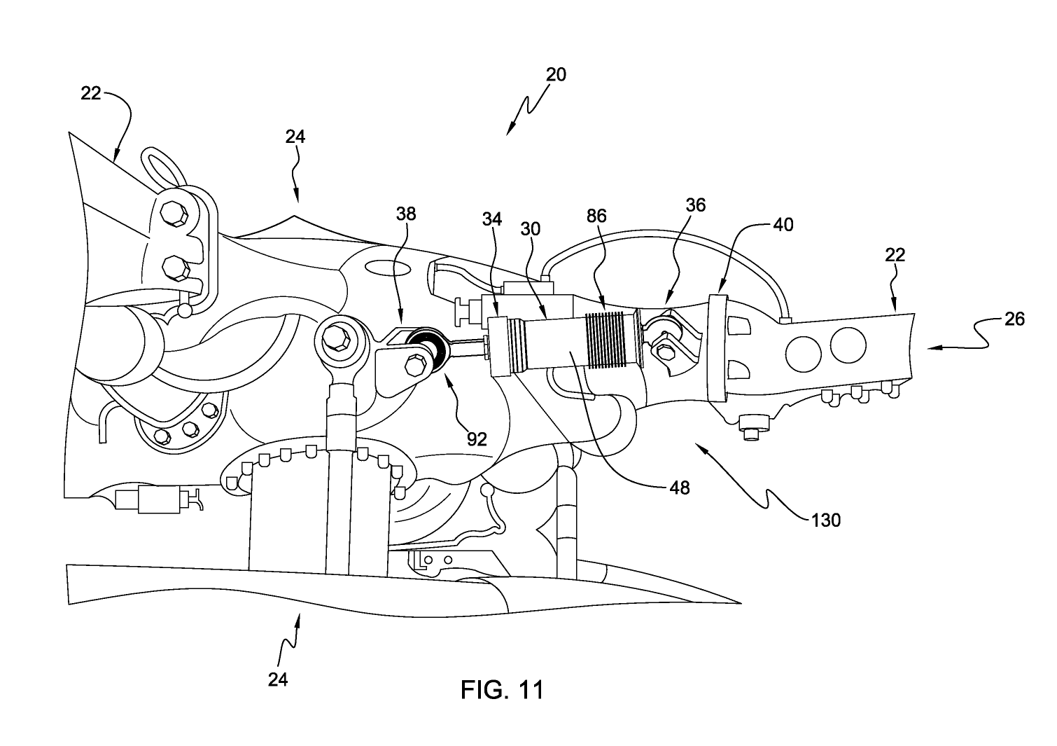

FIG. 12 illustrates a rotary wing system.

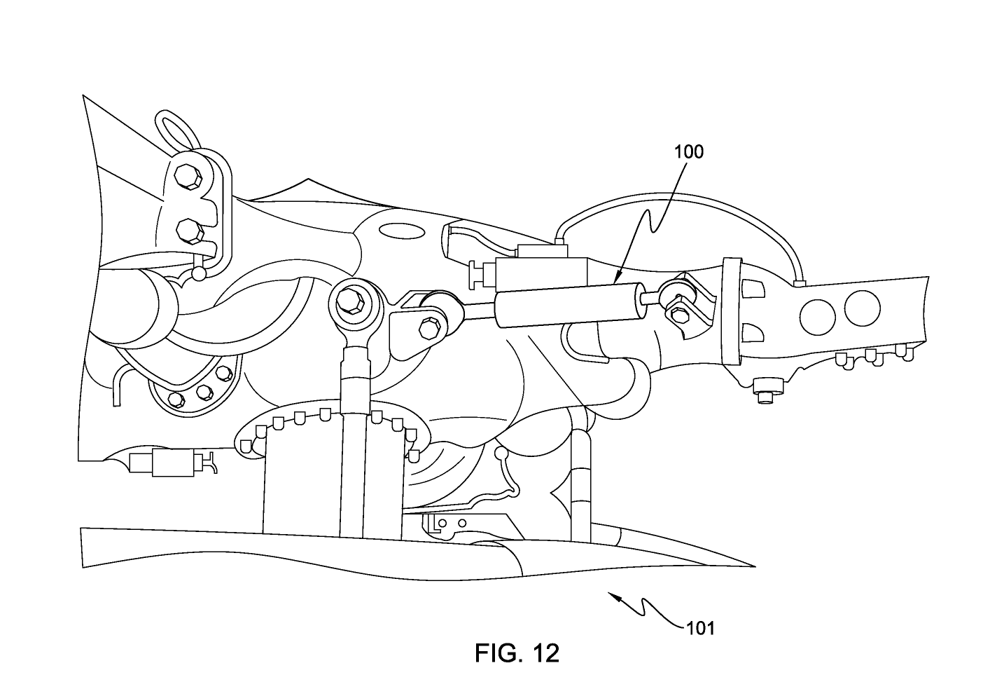

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a rotary wing system 20 with at least one rotating blade 22 rotating about a rotation axis 24, preferably in a rotor plane 26 of rotation. The rotary wing system 20 having a troublesome motion when rotating about the rotation axis 24 at least at a rotation operation frequency, the system including a fluid damper 30 with a damper fluid 32 for controlling the troublesome motion. The fluid damper 30 preferably having an inboard end 34 and an outboard end 36, the fluid damper inboard end 34 for attachment to a first rotary wing system inboard member 38 proximate the rotation axis 24 and the outboard end 36 for attachment to a second rotary wing system outboard member 40 distal from the rotation axis. The elastomeric member fluid damper 30 containing a damper fluid 32 volume in at least a first working chamber 42 and a second working chamber 44 which is worked by a relative motion between the first rotary wing system inboard member 38 and the second rotary wing system outboard member 40 to control the troublesome motion. Preferably the at least first working chamber 42 is an inboard chamber and the damper 30 includes the adjacent second working outboard chamber 44. The fluid damper 30 includes a volume compensator 46 in fluid communication with the damper fluid 32 through fluid conduits 60 which eventually communicate with the damper fluid volume in the working chambers 42,44.

In an embodiment the invention includes a rotary wing system 20 with at least one rotating blade 22 rotating about a rotation axis 24, the rotary wing system 20 having a troublesome motion when rotating about the rotation axis 24. The system including a fluid tubular damper 30 with a damper fluid 32 for controlling the troublesome motion. The fluid damper 30 having an first inboard end 34 and an second outboard end 36, the fluid damper first inboard end 34 attached to a first rotary wing system inboard member 38 proximate the rotation axis 24 and the second outboard end 36 attached to a second rotary wing system outboard member 40 distal from the rotation axis 24. The fluid damper 30 is comprised of a tubular housing 48 between the two ends of the damper, the fluid damper tubular housing second outboard end 50 terminated with a nonelastomeric end cap 52, and containing a damper fluid 32 in at least a first inboard variable volume nonelastomeric working chamber 42 and a second outboard variable volume nonelastomeric working chamber 44 which is worked by a nonelastomeric damper piston 54 and a relative motion between the first rotary wing system inboard member 38 and the second rotary wing system outboard member 40 to control the troublesome motion. The fluid damper 30 including a dynamically variable elastomeric volume compensator chamber 46 with its fluid 32 in fluid communication with the damper fluid 32 in the working chambers 42,44. Preferably the volume compensator chamber 46 volume varies dynamically with the relative motion of the damper 30. Preferably the volume compensator chamber fluid communication is a controlled communication with the fluid 32 flowed through control valves 56 towards the working chambers, preferably check valves, such as one way flow control check valves. Preferably the control valves 56 provide for one way flow of fluid 32 from the volume compensator chamber 46 towards the working chambers 42,44, and preferably inhibit flow through the control valves 56 from the working chambers 42,44 towards the volume compensator chamber 46. Preferably the fluid damper tubular housing first inboard end 34 is sealed with a sole single acting one ended bonded elastomeric member 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the tubular housing 48 and the second outboard end 36 wherein the damper piston shaft 78 connects the damper piston 54 with the fluid damper first inboard end 34 and the first rotary wing system inboard member 38 with the troublesome motion working the damper fluid 32 between the first inboard variable volume nonelastomeric working chamber 42 and the second outboard variable volume nonelastomeric working chamber 44.

Preferably the damper 30 includes a dynamic seal 80 between the tubular housing 48 and the nonelastomeric damper piston 54. Preferably the dynamic seal 80 is an elastomeric seal that moves with the piston 54 and seals the flow of fluid 32 past the piston 54, preferably the seal 80 is proximate the piston OD and piston damping orifices 82 are radially inward from the seal 80 and towards the shaft 78.

Preferably the damper 30 includes a wear interface bushing between the tubular housing 48 and the nonelastomeric damper piston 54. Preferably the damper includes an intermediate shaft support 83, the intermediate shaft support 83 disposed between the nonelastomeric end cap 52 and the bonded elastomeric member 70, the intermediate shaft support 83 supporting the shaft 78 and separating the dynamically variable volume compensator chamber 46 and the first inboard variable volume nonelastomeric working chamber 42. Preferably the damper intermediate shaft support 83 includes a dynamic seal 80 between the intermediate shaft support 83 and the damper piston shaft 78. Preferably the damper intermediate shaft support 83 includes a wear interface bushing 84 between the intermediate shaft support 83 and the damper piston shaft 78. Preferably the damper intermediate shaft support 83 includes at least a first control valve 56.

Preferably the fluid damper dynamically variable volume compensator chamber 46 includes a plurality of inboard fluid transfer ports 58, the inboard fluid transfer ports 58 connecting through at least one fluid transfer conduit 60 to a plurality of outboard fluid transfer ports 62, the outboard fluid transfer ports 62 communicating fluid with an outboard fluid reservoir 64 proximate the end cap and the second working chamber 44, preferably including at least one control valve 56 between the outboard fluid reservoir 64 and the second working chamber 44. Preferably the damper tubular housing 48 includes a plurality of external outwardly projecting projections 86 proximate the piston.

Preferably the fluid damper 30 comprises a helicopter lead-lag damper 30, and provides a long damper stroke in a limited damper package. Preferably the fluid damper 30 comprises a single acting piston 54, preferably with intermediate shaft support rod 88, the intermediate shaft support rod 88 received in a hollowed end of the shaft 78 and supporting shaft 78 motion. The intermediate shaft support rod 88 is preferably disposed intermediate between the piston end 90 of the shaft 78 and the nonelastomeric cap end 52 of the housing 48, preferably with the intermediate shaft support rod 88 grounded to the fluid damper tubular housing second outboard end nonelastomeric end cap 52. The damper 30 preferably provides for retrofitting existing in field helicopters which currently use hydraulic dampers 100. Preferably the damper 30 provides for controlling helicopter motions in articulated helicopter rotors.

In an embodiment the invention includes a method for controlling a rotating blade 22. The method comprises providing a rotating blade 22 which rotates about a rotation axis 24. The method comprises providing a fluid tubular damper 30 with a damper fluid 32, the fluid damper 30 having an first inboard end 34 and an second outboard end 36, the fluid damper 30 comprised of a tubular housing 48 between the two ends, the fluid damper tubular housing second outboard end 36 terminated with a nonelastomeric end cap 52, the damper 30 containing a damper fluid 32 in at least a first inboard variable volume nonelastomeric working chamber 42 and a second outboard variable volume nonelastomeric working chamber 44 which is worked by a relative motion nonelastomeric damper piston 54, the fluid damper 30 including a dynamically variable volume compensator chamber 46 in fluid communication with the damper fluid 32 in the working chambers 42,44, the fluid damper tubular housing first inboard end 34 sealed with a bonded elastomeric member 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the tubular housing 48 and the second outboard end 36 wherein the damper piston shaft 78 connects the damper piston 54 with the fluid damper first inboard end 34 and the first rotary wing system inboard member 38 with the troublesome motion working the damper fluid between the first inboard variable volume nonelastomeric working chamber 42 and the second outboard variable volume nonelastomeric working chamber 44.

Preferably the volume compensator chamber 46 volume changes dynamically with the relative motion, with the chamber 46 adjacent the elastomer 72, preferably with the compensator 46 comprised of an elastomeric volume compensating chamber. Preferably the controlled communication with fluid 32 in working chambers 42,44 is through control valves 56, preferably check valves, such as one way flow control check valves. Preferably the fluid damper tubular housing first inboard end 34 is a sole single acting one ended bonded elastomeric member 70.

The method includes attaching the fluid damper first inboard end 34 to a first rotary wing system inboard member 38 proximate a rotation axis 24. The method comprises attaching the second outboard end 36 to a second rotary wing system outboard member 40 distal from the rotation axis 24.

Preferably the nonelastomeric end cap 52 nonelastomerically terminates the second end.

In an embodiment the invention includes a rotating single acting one closed dead end blade damper system 130 for a blade 22 rotating about a rotation axis 24, the blade damper system 130 including a rotating single acting one closed dead end fluid damper 30 with a damper fluid 32 for controlling a troublesome blade motion, the fluid damper 30 having a first inboard elastomeric end 34 and a second distal nonelastomeric outboard end 36, the fluid damper first elastomeric inboard end 34 for attachment to a first inboard member 38 and the second outboard end 36 for attachment to a second outboard member 40, the fluid damper 30 comprised of a tubular housing 48 between the two ends, the fluid damper tubular housing second outboard end capped with an nonelastomeric end cap 52, the damper containing a damper fluid 32 in at least a first inboard variable volume nonelastomeric working chamber 42 and a second outboard variable volume nonelastomeric working chamber 44 which is worked by a relative motion nonelastomeric damper piston 54, the fluid damper 30 including a dynamically variable elastomeric volume compensator chamber 46 in controlled fluid communication with the damper fluid in the working chambers 42,44 through control valves 56, the fluid damper tubular housing first inboard end 34 sealed with a bonded elastomeric member 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the tubular housing 48 and the second outboard end 36 wherein the damper piston shaft 78 connects the damper piston 54 with the fluid damper first inboard end 34 and the first inboard member 38 with the troublesome blade motion working the damper fluid 32 between the first inboard variable volume nonelastomeric working chamber 42 and the second outboard variable volume nonelastomeric working chamber 44.

The damper preferably includes a dynamic elastomeric seal 80 between the tubular housing 48 and the nonelastomeric damper piston 54. The dynamic seal 80 moves with the piston 54 and seals the flow of fluid 32 past the piston 54, preferably with the seal 80 proximate piston OD and with the piston damping orifices 82 radially inward from the seal 80 and the piston OD and towards the shaft 78 and shaft axis 79. The damper preferably includes a wear interface bushing 84 between the tubular housing 48 and the nonelastomeric damper piston 54, preferably a reduced friction sliding wear ring. Preferably wear interface bushing wear rings 84 are disposed between the piston and the housing, and between the shaft and the intermediate shaft support and provide for reduced friction sliding, and preferably are comprised of Teflon polytetrafluoroethylene material.

The damper 30 preferably includes an intermediate shaft support 83, the intermediate shaft support 83 disposed between the nonelastomeric end cap 52 and the bonded elastomeric member 70, the intermediate shaft support 83 supporting the shaft 78 and separating the dynamically variable volume compensator chamber 46 and the first inboard variable volume nonelastomeric working chamber 42.

The damper 30 preferably includes an intermediate shaft support 83, wherein the intermediate shaft support 83 includes a dynamic seal 80 between the intermediate shaft support 83 and the damper piston shaft 78.

The damper 30 preferably includes an intermediate shaft support 83, wherein the intermediate shaft support 83 includes a wear interface bushing 84 between the intermediate shaft support 83 and the damper piston shaft 78.

The damper 30 preferably includes at least a first control valve 56 for controlling the flow of fluid 32 towards the piston 54, preferably one way flow valves which provide for fluid flow in directions into the working chambers 42,44 and inhibits flow out of the working chambers 42,44.

The damper 30 preferably includes a plurality of inboard fluid transfer ports 58, the inboard fluid transfer ports 58 connecting through at least one longitudinally outboardly extending fluid transfer conduit 60 to a plurality of outboard fluid transfer ports 62, the outboard fluid transfer ports 62 communicating fluid 32 with an outboard fluid reservoir 64 proximate the end cap 52 and the second working chamber 44, preferably the inboard fluid transfer ports 58 disposed proximate said volume compensator chamber 46 and said intermediate shaft support 83.

The damper 30 preferably includes at least one control valve 56 between the outboard fluid reservoir 64 and the second working chamber 44. The damper preferably includes a plurality of external outwardly radially projecting cooling fin projections 86 proximate the piston 54, the projections 86 projecting radially outward from the housing 48 in a direction away from the piston 54 and the working chambers 42,44.

In an embodiment the invention includes a method of making a damper 30. The method includes providing a housing 48 for containing a damper fluid 32 in at least a first working chamber 42 and at least a second working chamber 44. The method includes providing a second nonelastomeric outboard end 52 for capping a second outboard distal end of the housing 48. The method includes providing a bonded elastomeric member assembly 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the tubular housing 48, to contain a damper fluid 32 within the housing and provide for a relative axial motion of the damper piston shaft 78 relative to the housing and the second nonelastomeric outboard end 52, with the damper piston shaft 78 carrying the motion to a relative motion nonelastomeric damper internal piston 54 between a first inboard variable volume nonelastomeric working chamber 42 and a second outboard variable volume nonelastomeric working chamber 44.

In an embodiment the invention includes a method of repairing an aircraft with a troublesome blade motion. The method includes providing an aircraft 101 (preferably with an articulated helicopter rotor) with a used nonelastomeric hydraulic damper 100. Preferably the aircraft 101 is a helicopter with an articulated helicopter rotor. Preferably the used nonelastomeric hydraulic damper 100 is free of bonded elastomeric members, preferably free of annular elastomeric members with appreciable thickness relative to their respective diameters, preferably the hydraulic damper 100 is without nondynamic elastomeric bonded members containing the fluid and allowing motion. Preferably the used nonelastomeric hydraulic damper 100 has nonelastomeric end caps on both ends, one end with a shaft and a leaking dynamic seal. The method includes removing the used nonelastomeric hydraulic damper 100.

The method includes providing a bonded elastomeric fluid damper 30 having a first inboard elastomeric end 34 and a second distal nonelastomeric outboard end 36, the bonded elastomeric fluid damper 30 comprised of a housing 48 between the two ends, the fluid damper housing second outboard end capped with an nonelastomeric end cap 52, the damper containing a damper fluid 32 in at least a first inboard variable volume nonelastomeric working chamber 42 and a second outboard variable volume nonelastomeric working chamber 44 which is worked by a relative motion nonelastomeric damper piston 54, the fluid damper 30 including a volume compensator chamber 46 in fluid communication with the damper fluid 32, the fluid damper housing first inboard end 34 sealed with a bonded elastomeric member 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the housing 48 and the second outboard end 36 wherein the damper piston shaft 78 connects the damper piston 54 with the fluid damper first inboard end 34 and the first inboard member 38, and attaching the bonded elastomeric fluid damper 30 in place of the removed used nonelastomeric hydraulic damper 100 with the troublesome blade motion working the damper fluid 32 between the first inboard variable volume nonelastomeric working chamber 42 and the second outboard variable volume nonelastomeric working chamber 44.

In an embodiment the invention includes a fluid damper 30, the fluid damper 30 including a damper fluid 32 for controlling a troublesome motion. The fluid damper 30 having a first elastomeric end 34 and a second distal nonelastomeric end 36, the fluid damper first elastomeric end 34 for attachment to a first moving member 38 and the second end 36 for attachment to a second moving member 40.

The fluid damper 30 is comprised of a housing 48, the fluid damper housing second outboard end capped with an nonelastomeric end cap 52, the damper containing a damper fluid 32 in at least a first variable volume nonelastomeric working chamber 42 and a second variable volume nonelastomeric working chamber 44 which is worked by a relative motion nonelastomeric damper piston 54, the fluid damper 30 including a volume compensator chamber 46 in fluid communication with the damper fluid in the working chambers, the fluid damper housing first end sealed with a bonded elastomeric member 70, the bonded elastomeric member 70 including an intermediate elastomer 72 bonded between an inside nonelastomeric outer surface 74′and an outside nonelastomeric inner surface 76′ wherein the inside nonelastomeric opposite surface is grounded with a nonelastomeric damper piston shaft 78 and the outside nonelastomeric opposite surface is grounded with the housing 48 and the second end 36 wherein the damper piston shaft 78 connects the damper piston 54 with the fluid damper first end 34 and the first moving member 38 moving relative to the second moving member 40 working the damper fluid 32 between the first variable volume nonelastomeric working chamber 42 and the second variable volume nonelastomeric working chamber 44.

Preferably the damper 30 includes a dynamic elastomeric seal 80 between the housing 48 and the nonelastomeric damper piston 54. Preferably the dynamic elastomeric seal 80 moves with the piston 54 and seals the flow of fluid past the piston 54, preferably the seal 80 is proximate the piston OD and piston damping orifices 82 are radially inward from the seal 80 and between the shaft 78 and the piston OD seal 80.

Preferably the first variable volume nonelastomeric working chamber 42 and the second variable volume nonelastomeric working chamber 44 are worked by the relative motion nonelastomeric damper piston 54 to build up a fluid pressure of at least 400 psi, more preferably at least 450 psi.

In an embodiment the invention includes a fluid damper 30, the fluid damper 30 including a damper fluid 32 for controlling a troublesome motion. The fluid damper 30 having a first end 34 and a second distal nonelastomeric end 36, the fluid damper first end 34 for attachment to a first moving member 38 and the second end 36 for attachment to a second moving member 40.

The fluid damper 30 comprised of a housing 48, the fluid damper housing second end capped with an nonelastomeric end cap 52, the damper containing a damper fluid 32 in at least a first variable volume nonelastomeric working chamber 42 and a second variable volume nonelastomeric working chamber 44 which is worked by a relative motion nonelastomeric damper piston 54, the fluid damper 30 including a volume compensator chamber 46 in fluid communication with the working chambers' damper fluid 32, the fluid damper housing first end comprised of a bonded nonelastomeric shaft elastomeric means 70 for plugging the fluid damper housing first end wherein the fluid 32 is contained within the housing 48 and a nonelastomeric damper piston shaft 78 extends inside into the housing 48 towards the second end 36 wherein the damper piston shaft 78 connects with the damper piston 54, wherein the first moving member 38 moving relative to the second moving member 40 working the damper fluid 32 between the first variable volume nonelastomeric working chamber 42 and the second variable volume nonelastomeric working chamber 44.

In an embodiment the invention includes a rotating single acting blade damper 30 for a blade 22 rotating about a rotation axis 24, the blade damper 30 including a damper fluid 32 for controlling a troublesome blade motion. The damper 30 having a first inboard elastomeric end 34 and a second distal nonelastomeric outboard end 36, the fluid damper first elastomeric inboard end 34 for attachment to a first inboard member 38 and the second outboard end 36 for attachment to a second outboard member 40.

The fluid damper 30 is comprised of a housing 48, the fluid damper housing second outboard end capped with an nonelastomeric end cap 52, the damper containing a damper fluid 32 in at least a first inboard variable volume nonelastomeric working chamber 42 and a second outboard variable volume nonelastomeric working chamber 44 which is worked by a relative motion nonelastomeric damper piston 54 along a piston shaft axis 79, the fluid damper 30 including a dynamically variable elastomeric volume compensator chamber 46 in fluid communication with the working chamber damper fluid 32, the fluid damper tubular housing first inboard end 34 sealed with a bonded elastomeric member 70, the bonded elastomeric member 70 including an intermediate elastomer 72 bonded between an inside nonelastomeric inner member 74 and an outside nonelastomeric outer member 76 wherein the inside nonelastomeric inner member 74 is grounded with a damper piston shaft 78 and the outside nonelastomeric outer member 76 is grounded with the tubular housing 48 and the second outboard end 36 wherein the damper piston shaft 78 connects the damper piston 54 with the fluid damper first inboard end 34 and the first inboard member 38 with the troublesome blade motion working the damper fluid 32 between the first inboard variable volume nonelastomeric working chamber 42 and the second outboard variable volume nonelastomeric working chamber 44.

Preferably the first variable volume nonelastomeric working chamber 42 and the second variable volume nonelastomeric working chamber 44 is worked by the relative motion nonelastomeric damper piston 54 and the piston OD seal 80 to build up a fluid pressure of at least 400 psi, more preferably at least 450 psi.

Preferably the first inboard elastomeric end damper piston shaft 78 terminates with a first end rod end 92 for attachment to the first inboard member 38, the first end rod end 92 having an inner rod end member 93 with a rod end bore center axis 93′, and the second distal nonelastomeric outboard end 36 includes a second rod end for attachment to the second outboard member 40, the second rod end 94 having an inner rod end member 95 with a rod end bore center axis 95′, wherein the first end rod end inner rod end member rod end bore center axis 93′ is nonparallel with the second rod end inner rod end member rod end bore center axis 95′. Preferably the first end rod end inner rod end member rod end bore center axis 93′ is nonnormal with the piston shaft axis 79.

Preferably the damper includes a dynamic elastomeric seal 80 between the tubular housing 48 and the nonelastomeric damper piston 54, preferably the dynamic seal 80 moves with the piston 54 and seals the flow of fluid past the piston 54, preferably with the seal 80 proximate the piston OD and the piston damping orifices 82 between the OD seal 80 and the shaft axis 79.

Preferably the damper includes a wear interface bushing 84 between the tubular housing 48 and the nonelastomeric damper piston 54, preferably a reduced friction slide ring.

Preferably the damper 30 includes an intermediate shaft support 83, the intermediate shaft support 83 disposed between the nonelastomeric end cap 52 and the bonded elastomeric member 70, the intermediate shaft support 83 supporting the shaft 78 and separating the dynamically variable volume compensator chamber 46 and the first inboard variable volume nonelastomeric working chamber 42.

Preferably the damper 30 includes an intermediate shaft support 83, wherein the intermediate shaft support 83 includes a dynamic seal 80 between the intermediate shaft support 83 and the damper piston shaft 78.

Preferably the damper 30 includes an intermediate shaft support 83, wherein the intermediate shaft support 83 includes a wear interface bushing 84 between the intermediate shaft support 83 and the damper piston shaft 78.

Preferably the damper 30 includes at least a first control valve 56 for controlling the flow of fluid towards the piston 54, preferably one way flow valves which provide for fluid flow in a direction into the working chambers 42,44 and inhibits flow out of the working chambers 42,44.

Preferably the damper dynamically variable volume compensator chamber 46 includes a plurality of inboard fluid transfer ports 58, the inboard fluid transfer ports 58 connecting through at least one longitudinally outboardly extending fluid transfer conduit 60 to a plurality of outboard fluid transfer ports 62, the outboard fluid transfer ports 62 communicating fluid with an outboard fluid reservoir 64 proximate the end cap 52 and the second working chamber 44. Preferably the damper 30 includes at least one control valve 56 between the outboard fluid reservoir 64 and the second working chamber 44.

Preferably the damper housing 48 includes a plurality of external outwardly radially projecting projections 86 proximate the piston 54, the projections 86 projecting radially outward from the housing 48 in direction away from the piston 54 and the working chambers 42,44, and preferably normal to the shaft axis 79.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A rotary wing system with at least one rotating blade rotating about a rotation axis, said rotary wing system having a troublesome motion when rotating about said rotation axis, said system including a fluid tubular damper with a damper fluid for controlling said troublesome motion,
said fluid damper having an first end and an second end, said fluid damper first end attached to a first rotary wing system member proximate said rotation axis and said second end attached to a second rotary wing system member distal from said rotation axis, said fluid damper comprised of a tubular housing, said fluid damper tubular housing second end terminated with an end cap, said fluid damper containing a damper fluid in at least a first variable volume working chamber and a second variable volume working chamber which is worked by a damper piston and a relative motion between said first rotary wing system member and said second rotary wing system member to control said troublesome motion, said fluid damper including a dynamically variable volume compensator chamber in fluid communication with said damper fluid in said working chambers, said fluid damper tubular housing first end sealed with a bonded elastomeric member, said bonded elastomeric member including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said tubular housing and said second end wherein said damper piston shaft connects said damper piston with said fluid damper first end and said first rotary wing system member with said troublesome motion working said damper fluid between said first variable volume working chamber and said second variable volume working chamber.

2. A system as claimed in claim 1, including a dynamic seal between said tubular housing and said damper piston.

3. A system as claimed in claim 1 including a wear interface bushing between said tubular housing and said damper piston.

4. A system as claimed in claim 1 including an intermediate shaft support, said intermediate shaft support disposed between said end cap and said bonded elastomeric member, said intermediate shaft support supporting said shaft.

5. A system as claimed in claim 4 wherein said intermediate shaft support comprises an intermediate shaft support rod, said intermediate shaft support rod received in an end of the piston shaft and supporting a shaft motion.

6. A system as claimed in claim 4 wherein said intermediate shaft support comprises an intermediate shaft support rod, said intermediate shaft support rod received in an end of the piston shaft and supporting a shaft motion, said shaft support rod grounded to said housing second nonelastomeric cap.

7. A system as claimed in claim 4 wherein said intermediate shaft support separates said dynamically variable volume compensator chamber and said first variable volume working chamber, and includes a dynamic seal between said intermediate shaft support and said damper piston shaft.

8. A system as claimed in claim 4 wherein said intermediate shaft support separates said dynamically variable volume compensator chamber and said first variable volume working chamber, and includes a wear interface bushing between said intermediate shaft support and said damper piston shaft.

9. A system as claimed in claim 4 wherein said intermediate shaft support includes at least a first control valve.

10. A system as claimed in claim 1 wherein said fluid damper dynamically variable volume compensator chamber includes a plurality of inboard fluid transfer ports, said inboard fluid transfer ports connecting through at least one fluid transfer conduit to a plurality of outboard fluid transfer ports, said outboard fluid transfer ports communicating fluid with an outboard fluid reservoir proximate said end cap and said second working chamber.

11. A system as claimed in claim 10 including at least one control valve between said outboard fluid reservoir and said second working chamber.

12. A system as claimed in claim 1 wherein said fluid damper tubular housing includes a plurality of external outwardly projecting projections proximate said piston.

13. A method for controlling a rotating blade, the method comprising: providing a rotating blade which rotates about a rotation axis,
providing a fluid tubular damper with a damper fluid,
said fluid damper having an first end and an second end, said fluid damper comprised of a tubular housing, said fluid damper tubular housing second end terminated with a end cap, said damper containing a damper fluid in at least a first variable volume working chamber and a second variable volume working chamber which is worked by a relative motion damper piston, said fluid damper including a dynamically variable volume compensator chamber in fluid communication with said damper fluid, said fluid damper tubular housing first end sealed with a bonded elastomeric member, said bonded elastomeric member including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said tubular housing and said second end wherein said damper piston shaft connects said damper piston with said fluid damper first end and said first rotary wing system member with said troublesome motion working said damper fluid between said first variable volume working chamber and said second variable volume working chamber,
attaching said fluid damper first inboard end to a first rotary wing system inboard member proximate a rotation axis,
attaching said second outboard end to a second rotary wing system outboard member distal from said rotation axis.

14. (canceled)

15. A rotating single acting blade damper for a blade rotating about a rotation axis,
said blade damper comprised a damper fluid for controlling a troublesome blade motion,
said damper having a first inboard elastomeric end and a second distal nonelastomeric outboard end, said damper first elastomeric inboard end for attachment to a first inboard member and said second outboard end for attachment to a second outboard member,
said damper comprised of a tubular housing, said damper tubular housing second end capped with an end cap, said damper containing said damper fluid in at least a first inboard variable volume nonelastomeric working chamber and a second outboard variable volume nonelastomeric working chamber which is worked by a relative motion damper piston, said damper including a volume compensator chamber in fluid communication with said damper fluid, said damper tubular housing first end sealed with a bonded elastomeric member, said bonded elastomeric member including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said tubular housing and said second end wherein said damper piston shaft connects said damper piston with said fluid damper first end and said first inboard member with said troublesome blade motion working said damper fluid between said first variable volume working chamber and said second variable volume working chamber.

16. A damper as claimed in claim 15 including an elastomeric seal between said tubular housing and said damper piston.

17. A damper as claimed in claim 15 including a bushing between said tubular housing and said damper piston.

18. A damper as claimed in claim 15 including a shaft support, said shaft support disposed between said end cap and said bonded elastomeric member, said shaft support supporting said shaft.

19. A damper as claimed in claim 15 including an intermediate shaft support, wherein said intermediate shaft support includes a dynamic seal and a wear interface bushing between said intermediate shaft support and said damper piston shaft.

20. A damper as claimed in claim 15 including an intermediate shaft support, wherein said intermediate shaft support comprises an intermediate shaft support rod, said intermediate shaft support rod received in an end of the piston shaft and supporting a shaft motion.

21. A damper as claimed in claim 15 including at least a first control valve for controlling the flow of fluid towards said piston.

22. A damper as claimed in claim 15 wherein said damper includes a plurality of inboard fluid transfer ports, said inboard fluid transfer ports connecting through at least one longitudinally outboardly extending fluid transfer conduit to a plurality of outboard fluid transfer ports, said outboard fluid transfer ports communicating fluid with an outboard fluid reservoir proximate said end cap and said second working chamber.

23. A damper as claimed in claim 20 including at least one control valve between said outboard fluid reservoir and said second working chamber.

24. A damper as claimed in claim 13 wherein said damper tubular housing includes a plurality of external outwardly radially projecting projections proximate said piston, said projections projecting radially outward from said housing in direction away from said piston and said working chambers.

25. A method of making a damper, said method including:
providing a housing for containing a damper fluid in at least a first working chamber and at least a second working chamber,
providing an second nonelastomeric end for capping an second distal end of said housing,
providing a bonded elastomeric member assembly, said bonded elastomeric member assembly including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said housing to contain a damper fluid within said housing and provide for a relative axial motion of said damper piston shaft relative to said housing and said second nonelastomeric end, with said damper piston shaft carrying said motion to a relative motion damper internal piston between a first variable volume nonelastomeric working chamber and a second variable volume nonelastomeric working chamber.

26. A method of repairing an aircraft with a troublesome blade motion, said method including:
providing an aircraft with a used nonelastomeric hydraulic damper
removing said used nonelastomeric hydraulic damper,
providing a bonded elastomeric fluid damper having a first inboard elastomeric end and a second distal nonelastomeric outboard end,
said bonded elastomeric fluid damper comprised of a housing, said fluid damper housing second end capped with an end cap, said damper containing a damper fluid in at least a first inboard variable volume nonelastomeric working chamber and a second outboard variable volume nonelastomeric working chamber which is worked by a relative motion damper piston, said fluid damper including a volume compensator chamber in fluid communication with said damper fluid, said fluid damper housing first end sealed with a bonded elastomeric member, said bonded elastomeric member including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said housing and said second end wherein said damper piston shaft connects said damper piston with said fluid damper first end and said first inboard member, and attaching said bonded elastomeric fluid damper in place of said removed used nonelastomeric hydraulic damper with said troublesome blade motion working said damper fluid between said first variable volume working chamber and said second variable volume working chamber.

27. A fluid damper, said fluid damper including a damper fluid for controlling a troublesome motion,
said fluid damper having a first elastomeric end and a second distal nonelastomeric end, said fluid damper first elastomeric end for attachment to a first moving member and said second end for attachment to a second moving member,
said fluid damper comprised of a housing, said fluid damper housing second end capped with an end cap, said damper containing a damper fluid in at least a first variable volume nonelastomeric working chamber and a second variable volume nonelastomeric working chamber which is worked by a relative motion nonelastomeric damper piston, said fluid damper including a volume compensator chamber in fluid communication with said damper fluid, said fluid damper housing first end sealed with a bonded elastomeric member, said bonded elastomeric member including an intermediate elastomer bonded between an inside nonelastomeric outer surface and an outside nonelastomeric inner surface wherein said inside nonelastomeric outer surface is grounded with a nonelastomeric damper piston shaft and said outside nonelastomeric inner surface is grounded with said housing and said second end wherein said damper piston shaft connects said damper piston with said fluid damper first end and said first moving member moving relative to said second moving member working said damper fluid between said first variable volume working chamber and said second variable volume working chamber.

28-31. (canceled)

32. A fluid damper, said fluid damper including a damper fluid for controlling a troublesome motion,
said fluid damper having a first end and a second distal nonelastomeric end, said fluid damper first end for attachment to a first moving member and said second end for attachment to a second moving member,
said fluid damper comprised of a housing, said fluid damper housing second end capped with an end cap, said damper containing a damper fluid in at least a first variable volume nonelastomeric working chamber and a second variable volume nonelastomeric working chamber which is worked by a relative motion nonelastomeric damper piston, said fluid damper including a volume compensator chamber in fluid communication with said damper fluid, said fluid damper housing first end comprised of a bonded nonelastomeric shaft elastomeric means for plugging said fluid damper housing first end wherein said fluid is contained within said housing and a nonelastomeric damper piston shaft extends inside into said housing towards said second end wherein said damper piston shaft connects with said damper piston, wherein said first moving member moving relative to said second moving member working said damper fluid between said first variable volume working chamber and said second variable volume working chamber.

33. A rotating single acting blade damper for a blade rotating about a rotation axis,
said blade damper including a fluid damper with a damper fluid for controlling a troublesome blade motion,
said fluid damper having a first inboard elastomeric end and a second distal nonelastomeric outboard end, said fluid damper first elastomeric inboard end for attachment to a first inboard member and said second outboard end for attachment to a second outboard member,
said fluid damper comprised of a housing, said fluid damper housing second outboard end capped with a nonelastomeric end cap 52, said damper containing a damper fluid in at least a first inboard variable volume nonelastomeric working chamber and a second outboard variable volume nonelastomeric working chamber which is worked by a relative motion nonelastomeric damper piston along a piston shaft axis, said fluid damper including a dynamically variable elastomeric volume compensator chamber in fluid communication with said damper fluid, said fluid damper tubular housing first inboard end sealed with a bonded elastomeric member, said bonded elastomeric member including an intermediate elastomer bonded between an inside nonelastomeric inner member and an outside nonelastomeric outer member wherein said inside nonelastomeric inner member is grounded with a damper piston shaft and said outside nonelastomeric outer member is grounded with said tubular housing and said second outboard end wherein said damper piston shaft connects said damper piston with said fluid damper first inboard end and said first inboard member with said troublesome blade motion working said damper fluid between said first inboard variable volume nonelastomeric working chamber and said second outboard variable volume nonelastomeric working chamber.

34-47. (canceled)
